(19) United States
(12) Patent Application Publication
(10) Pub. No.: US 2007/0256068 A1
(43) Pub. Date: Nov. 1, 2007

(54) Product updating with custom actions

(75) Inventors: Paul C. Barr, Redmond, WA (US); Jeffrey M. James, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/414,998

(22) Filed: May 1, 2006

(51) Int. Cl. G06F 9/44

(52) U.S. Cl. 717/168

(57) ABSTRACT

A properly configured custom action allows a software product to be efficiently and effectively maintained. A custom action is associated with a software product. When the software product is installed on the client device, the custom action facilitates updating on the client. The custom action detects a recache/reinstall command from the source. The custom action identifies the product source, builds a model of the product, and identifies which updates to apply to the software product. When the updates have been identified, the custom action registers the updates on the client computer.

### BACKGROUND

Many small to medium sized business organizations have a network infrastructure to allow software product distribution and updating by a network administrator. A client user may have rights to use products on the client but not have rights to install or update products on the client.

A network administrator may update software products on a client by manually updating the product directly on the client. Such manual updating is time consuming because the network administrator must physically go to each client for the updating. A network administrator may also update a product via a network. The network administrator may update product files associated with a source. The network administrator may then deploy the updated product files to one or more client computers. Such source updating precludes other updating methodologies and causes abandonment issues when the source is out of sync with the client computer. A network administrator may also deploy binary client updates to one or more clients without updating the source. Such binary client updates may be inefficient for some security models and for multi-installer products.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

A custom action is associated with a client device to leverage the privileges and install product updates on a lockdown client device. The custom action allows product updates to be registered on the client device. The custom action detects a recache/reinstall command received by the client device. The custom action scans the source to determine applicable updates for the client device. The applicable updates are registered on the client device. When registered, the updates have the appropriate privileges and may be applied.

In this manner, the custom action provides efficient update deployment that eliminates abandonment issues. The custom action also facilitates update deployment on multi-installer devices by leveraging privileges to access updates for registration on a client device.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary computing device;

FIG. 2 represents one exemplary environment for deploying product updates in a network;

FIG. 3 represents one exemplary system overview for product updating with custom actions;

FIG. 4 represents an operational flow diagram for product updating with custom actions; and

FIG. 5 represents an operational flow diagram for executing a custom action to register updates.

### DETAILED DESCRIPTION

Embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments described herein are referred to alternatively as operations, steps or modules.

In a small to medium sized business organization, software products are installed and/or updated on client machines in many different ways. When a user has administrative rights to a client device, the user may download software products from the Internet or install a software product from a computer-readable medium. Such rights are rarely issued to a user in a typical business setting because the business organization desires maintaining control over the software that the user has on the client device. For these reasons, many business organizations have restricted privileges on client devices. These restricted privileges may prohibit the client from installing or updating software products.

In such situations, a network administrator may have the responsibility of maintaining software on client devices. To maintain software products on a client device, the network administrator may be required to manually maintain the software on each client device. The network administrator logs onto the client device with heightened privileges. The network administrator may then maintain the software product on the client device (e.g. install product and/or install updates). Maintaining software products in this manner may be acceptable in business organizations with a small number of client devices. However, as the number of client devices increase, so does the time and labor required to maintain software products on each of the client devices.

When a network administrator desires maintaining a software product on several devices, the network and security structure of the business organization may allow the network administrator to utilize a software deployment technology to remotely maintain software on the client devices. Some software products include multiple installers. In such a situation, the software product may include a core installer that is associated with the application binary. The software may also include multiple satellite installers that are associated with application resources. Multi-installer software products may present problems for prior product updating methodologies.

A properly configured custom action provides an efficient and effective updating methodology. A properly configured custom action also allows a software product with multiple installers to be efficiently and effectively updated. A custom action may be associated with the core installer of the software product. When the core installer of a software product is installed on the client device, the custom action facilitates updating on the client. The custom action detects a recache/reinstall command from the source. The custom action identifies the source, builds a model of the product, and identifies which updates to apply to the software product. When the updates have been identified, the custom action registers the updates on the client device.

In general, the custom action leverages privileges to install updates on a lockdown client device. The custom action allows software updates for multi-installer products to be installed on a client. The custom action further provides a new methodology for installing software updates for single installer products. In this manner, abandonment issues are eliminated and multi-installer software updates may be easily deployed and installed on client devices.

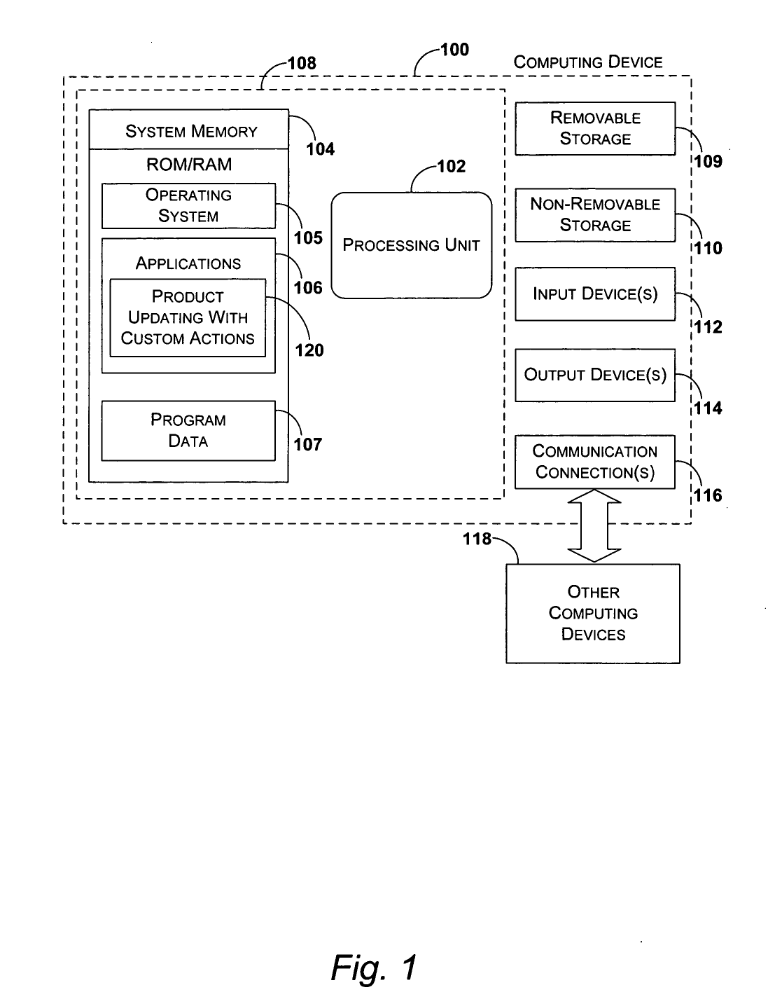

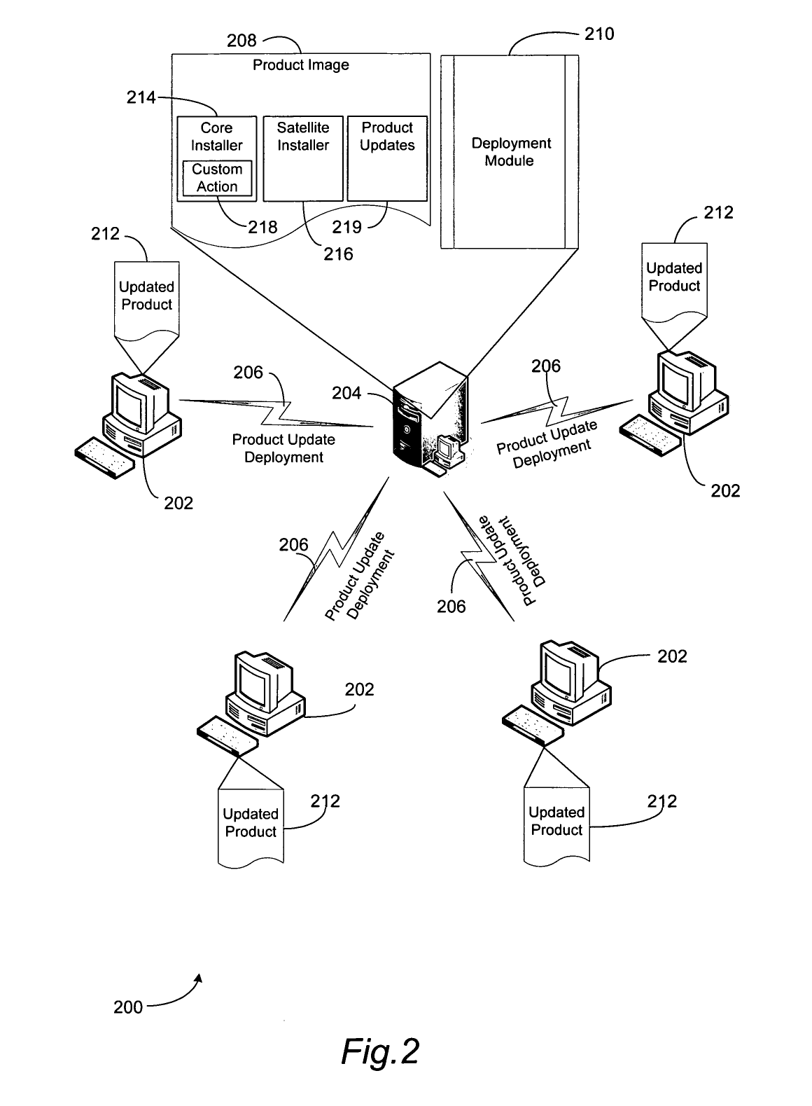

FIG. 2 represents one exemplary environment for updating a product in a network. System 200 represents a modular overview of a computing environment. System 200 may include computing device 202. Computing device 202 may include a desktop computing device, mobile computing device, a laptop, a personal digital assistant, a notebook computer, and/or any other type of computing device functional to store data. In one aspect, computing device 202 includes computing device 100 as exemplified in FIG. 1.

System 200 also includes server 204. Server 204 may be associated with an administrator terminal. Server 204 may include any type of server that facilitates product deployment in a networked environment. Server 204 is in communication with computing device 202 via network connection 206. Network connection 206 may include a hardwired network connection and/or a wireless network connection. Network connection 206 may include any type of network connection functional to transmit data between a computing device and a server. Network connection 206 includes any type of network connection that facilitates product updates deployment.

In the distributed environment, server 204 may include product image 208 and deployment module 210. For example, an administrator may associate product image 208 with server 204 to facilitate product deployment to client 202. Client 202 may install product 212 on client 202.

In one embodiment, product 212 is a multi-installer product. In such a situation, product image 208 includes core installer 214 and satellite installer(s) 216. Core installer 214 may include custom action 218. Core installer 214 is deployed by deployment module 210 during product deployment to client 202. When installed, client 202 may include at least core installer 214 having custom action 218. Even though the disclosure herein references that custom action 218 is associated with core installer 214, custom action 218 may be associated with client 202 by direct association, a separate installation process and/or any other manner for associating a custom action with client 202 to leverage privileges.

Product image 208 may also include product updates 219. Product updates 219 may include one or more patches for product image 208. The patches may be associated with product updates 219 on a random basis as fixes for product image 208 are realized. Product updates 219 may include binary client updates. The binary client updates include a set of changes to the file to facilitate a new version of product image 208. In one aspect, product updates 219 are not applied to the installers that live on server 204. Product updates 219 are applied to the installers associated with client 212. In this manner, server 204 includes a baseline for a product and abandonment does not become an issue when updating.

In one embodiment, core installer 214 is installed on client 202 during an initial product deployment. During an update action, a network administrator instantiates a recache/reinstall action and deployment module 210 transmits a recache/reinstall command to client 202. Custom action 218 detects the recache/reinstall command and leverages the privileges of core installer 214 to install product update(s) 219 when client 202 is in a lockdown mode.

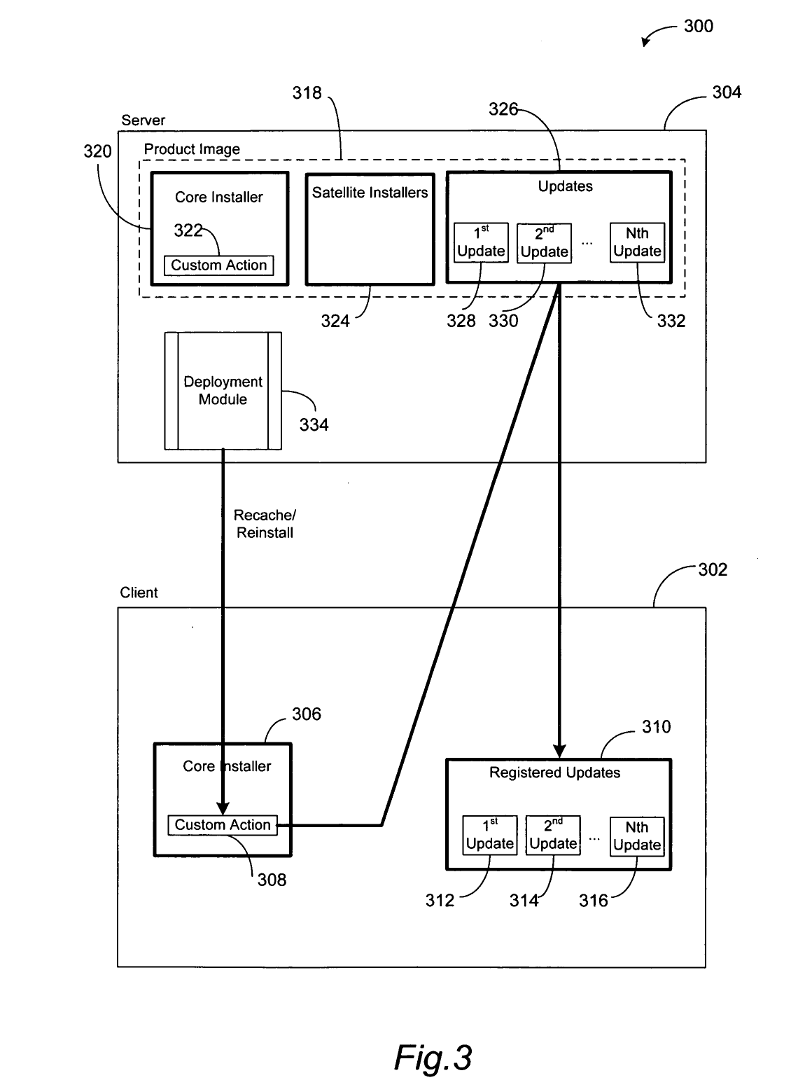

FIG. 3 represents one exemplary system overview for product updating with a custom action. System 300 represents a modular overview of client 302 and server 304. System 300 is but one example of elements associated with client 302 and server 304. For example, as indicated in FIG. 3, product image 322 is a multi-installer product. Product image 322, however, may also include a single installer product and facilitate product updating with a custom action.

System 300 may be integrated as a combination of software and hardware elements, an operating system or any combination thereof. Hardware, databases, software, applications, and/or programs referenced herein may be integrated as a single element or include various elements in communication with one another. Software and/or hardware elements are depicted herein for explanatory purposes only and not for limiting the configuration to multiple elements or a single element performing several functions unless specifically specified herein. For example, as depicted in FIG. 3, system 300 includes client 302 having core installer 306, custom action 308, registered updates 310, first update 312, second update 314, and Nth update 316. Reference numbers 306-316 may include separate programs, separate databases and separate hardware. Reference numbers 306-316 may also include a single program or any combination of single and multiple programs. Similarly, system 300 includes server 304 having product image 318, core installer 320, custom action 322, satellite installers 324, updates 326, first update 328, second update 330, Nth update 332 and deployment module 334. Reference numbers 318-334 may include separate programs, separate databases and separate hardware. Reference numbers 318-334 may also include a single program or any combination of single and multiple programs.

Server 304 may be associated with product image 318. Even though not depicted in FIG. 3, product image 318 may be a single installer product image. Product image 318 may also be a product image for a multi-installer product. Product image 318 includes core installer 320 and satellite installers 324. Core installer 320 includes the binary application bits for the product. For example, if product image 318 is a product image for “MICROSOFT OFFICE”, core installer 320 may include the binary bits for “MICROSOFT WORD”, “MICROSOFT EXCEL”, “MICROSOFT OUTLOOK”, “MICROSOFT POWERPOINT”, and/or “MICROSOFT ACCESS.” Core installer 320 may also include custom action 322. As is more fully set forth below, custom action 322 leverages privileges of core installer 320 to facilitate the registration of updates 326 on client 302.

In the multi-installer embodiment, product image 318 may also include satellite installers 324. Satellite installers 324 may include any number of installers. In one aspect, satellite installers 324 include resource installers associated with core installer 320. Resource installers may include language resources, language resources for proofing, and/or any other type of resource associated with a language or geographic area.

Updates 326 may include first update 328, second update 330, and Nth update 332. Updates 326 may be patches, binary client patches and/or the like. As a network administrator receives updates and/or fixes to a software product, the network administrator may associate updates 326 with product image 318 to facilitate the updating of the software product on client 302.

Deployment module 334 may be a single deployment module. In one aspect, deployment module 334 includes MICROSOFT ACTIVE DIRECTORY. Deployment module 334 may deploy a recache/reinstall command. For example, a network administrator may associate updates 326 with product image 318. The network administrator may instantiate deployment module 334 to deploy a recache/reinstall command to client 302 in order to update client 302 with updates 326.

Core installer 306 may include a client version of core installer 320 that was initially deployed to install the software product on client 302. Core installer 306 may include custom action 308. As previously stated, even though FIG. 3 depicts custom action 308 associated with core installer 306, custom action 308 may be associated with client 302 in any manner that allows custom action 308 to leverage privileges and register updates.

Custom action 308 detects the recache/reinstall command sent to client 302 and leverages privileges of core installer 306 to register updates. Custom action 308 finds the source of the recache/reinstall command by scanning the source. Custom action 308 builds a model of product image 318. For example, custom action 308 determines that a multi-install product exists on the server. Custom action 308 identifies core installer 320, satellite installers 318 and updates 326. Custom action 308 also identifies that updates exist for product image 318. Custom action 308 may also identify, which updates of updates 326 have been previously applied to client 302. In such a situation, unapplied updates are registered. Custom action 308 leverages privileges associated with core installer 306 to register updates. When registered updates 310 exist on client 302, registered updates 310 may be applied via a user process or any other type of process of applying updates to a client.

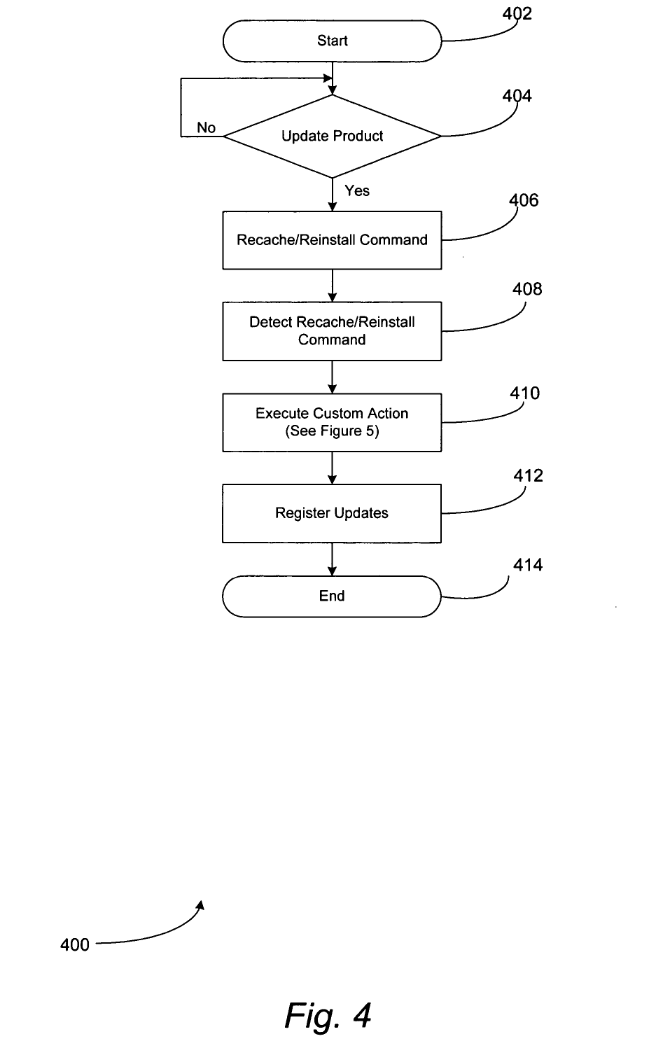

FIG. 4 represents an operational flow diagram for product updating with custom actions. Operational flow 400 begins at start operation 402 and flows to decision operation 404. At decision operation 404 it is decided whether to update a product. Such a decision may include a network administrator decision. For example, a network administrator may receive patches for a software product and associate the patches with a product image.

Where updating is not desired, operational flow 400 loops back and waits for product updating to instigate. Where product updating is desired, operational flow 400 continues to operation 406. At operation 406, a recache/reinstall command is deployed. The network administrator may instigate the recache/reinstall command via a deployment module and the recache/reinstall command may be sent to one or more clients associated with a network.

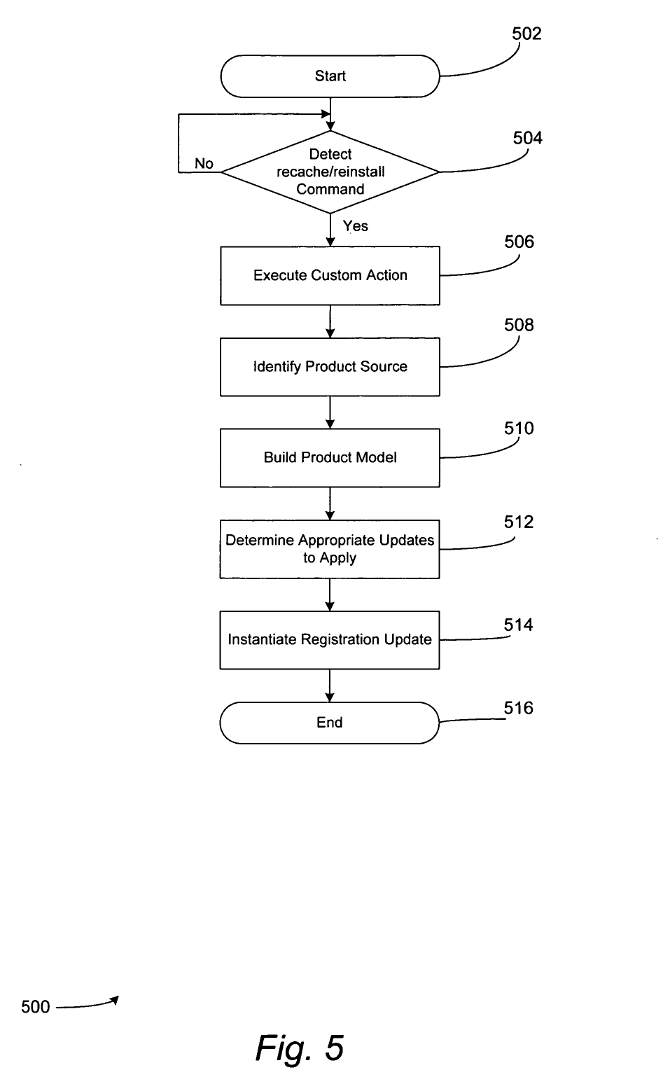

Operational flow 400 continues to operation 408 where the custom action detects the recache/reinstall command. In one aspect, the custom action intercepts the recache/reinstall action and the custom action is then triggered. At operation 410, the custom action is executed. Operation 410 is more fully set forth in association with FIG. 5. Operational flow 400 continues to operation 412, where updates associated with a source are registered. The custom action leverages privileges to register product updates on a locked-down client. Operational flow continues to end operation 414.

FIG. 5 represents an operational flow diagram for executing a custom action. Operational flow 500 begins at start operation 502 and continues to decision operation 504. At decision operation 504, it is determined whether a recache/reinstall command is detected. Where a recache/reinstall command is not detected, operational flow 500 loops back up. Where a recache/reinstall command is detected, operational flow 500 continues to operation 506 where the custom action is executed. In one aspect, the recache/reinstall command is a trigger for executing the custom action.

Operational flow 500 continues to operation 508 where the product source is identified. The custom action may include code for identifying the source of the recache/reinstall command and determining which product image is to be updated. At operation 510 a product model is built. The product model may include determining whether the product model is a single-installer program or a multi-installer program. The product model may include determining a product version and/or determining data associated with installers, updates and/or the like.

At operation 512, appropriate updates are determined. For example, a product image may have ten updates associated therewith. The client, however, may have updates one through eight and need updates nine and ten. The custom action determines which updates are required and instantiates registration of those updates as identified by operation 514. In one aspect, the custom action leverages privileges associated with a core installer to register updates on the client. Operational flow 400 then continues to end operation 516.

In this manner, the custom action provides efficient update deployment that eliminates abandonment issues. The custom action also facilitates update deployment on multi-installer devices by leveraging privileges associated with a core installer to access updates for registration on a client device.

Referring to FIG. 1, an exemplary system for implementing the invention includes a computing device, such as computing device 100. In a basic configuration, computing device 100 may include any type of stationary computing device or a mobile computing device. Computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include application 120 for product patching with custom actions. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included.

Computing device 100 also contains communication connection(s) 116 that allow the device to communicate with other computing devices 118, such as over a network or a wireless network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-implemented method for leveraging privileges with a custom action to register product updates, the method comprising:
associating a custom action with a client device;
detecting an update command;
executing the custom action when the update command is detected; and
leveraging administrative privileges to register updates on the client device.

2. The computer-implemented method of claim 1, wherein associating a custom action with a client device includes associating the custom action with a core installer and associating the core installer with the client device.

3. The computer-implemented method of claim 1, wherein-the update command includes a recache/reinstall command.

4. The computer-implemented method of claim 1, further comprising determining a source of the update command.

5. The computer-implemented method of claim 4, further comprising building a model of a product associated with the source.

6. The computer-implemented method of claim 5, further comprising determining updates to register with the client device.

7. The computer-implemented method of claim 1, further comprising applying the registered updates to a software product associated with the client device.

8. The computer-implemented method of claim 1, wherein the updates include patches.

9. A computer-readable medium having computer-executable instructions for leveraging administrative privileges on a client device to register updates on the client device; the computer-executable instructions comprising:
associating a custom action with the client device during installation of a product on the client device;
detecting a recache/reinstall command from a source;
executing the custom action when the recache/reinstall command is detected; and
leveraging administrative privileges to register updates on the client device.

10. The computer-readable medium of claim 9, wherein associating the custom action with the client device includes associating the custom action with a core installer and associating the core installer with the client device during installation.

11. The computer-readable medium of claim 9, further comprising determining the source of the recache/reinstall command.

12. The computer-readable medium of claim 11, further comprising building a product model of a product associated with the source.

13. The computer-readable medium of claim 12, further comprising determining updates to register with the client device.

14. The computer-readable medium of claim 9, further comprising applying the registered updates to a product associated with the client device.

15. The computer-readable medium of claim 9, wherein the updates include patches.

16. The computer-readable medium of claim 9, wherein the product includes a single installer product.

17. The computer-readable medium of claim 9, wherein the product includes a multi-installer product.

18. A computer-implemented method for leveraging administrative privileges on a client device to register patches on the client device, the method comprising:
associating a custom action with a core installer of a multi-installer software product;
associating the core installer with the client device;
executing the custom action when the custom action detects a recache/reinstall command from a source, wherein the custom action:
identifies the source of the recache/reinstall command;
models the multi-installer software product;
determines patches to register on the client device; and
leverages the privileges of the core installer to register the determined patches on the client device.

19. The computer-implemented method of claim 18, further comprising applying the patches to a software product associated with the client device.

20. The computer-implemented method of claim 18, wherein determining patches to register includes determining priorly registered patches and registering patches that are not priorly registered.
